(19) United States
(12) Patent Application Publication
(10) Pub. No.: US 2025/0096626 A1
(43) Pub. Date: Mar. 20, 2025

(54) ELECTRIC MOTOR COOLING CHANNELS

(71) Applicant: Dana Automotive Systems Group, LLC, Maumee, OH (US)

(72) Inventors: Steven VANHEE, Hooglede (BE); Jaywant S. PAWAR, Pune (IN); Joachim DRUANT, Houthulst (BE)

(21) Appl. No.: 18/886,255

(22) Filed: Sep. 16, 2024

Related U.S. Application Data
(60) Provisional application No. 63/583,798, filed on Sep. 19, 2023.

(51) Int. Cl. H02K 1/20; H02K 9/19

(52) U.S. Cl. CPC H02K 1/20; H02K 9/19

(57) ABSTRACT

Systems are provided for an electric motor. In one example, the electric motor includes a stator comprising a coolant passage shaped in stator laminations. The coolant passage is non-linear and configured to flow coolant in two or more planes.

### CROSS REFERENCE TO RELATED APPLICATION

The present application claims priority to U.S. Provisional Application No. 63/583,798, entitled “ELECTRIC MOTOR COOLING CHANNELS”, and filed on Sep. 19, 2023. The entire contents of the above-listed application are hereby incorporated by reference for all purposes.

### TECHNICAL FIELD

The present description relates generally to systems for cooling a stator of an electric motor via wavy channels.

### BACKGROUND AND SUMMARY

Vehicles may be equipped with electrical energy storage devices to decrease vehicular contributions to global warming. An electric motor may be configured to operate via electrical energy stored in the energy storage devices, wherein the electric motor may drive one or more wheels of the vehicle. Like an engine, the electric motor may demand cooling during certain operating conditions.

An efficiency of the electric motor may be at least partially based on an efficiency of the cooling provided to the electric motor and its various components. Stators may represent one component in which previous examples of cooling may be insufficient. For example, previous examples of coolant passages may flow coolant linearly through the stator and towards its windings. This approach may not provide a desired amount of cooling during operating conditions with higher electric motor demands.

In one example, the issues described above may be addressed by an electric motor including a housing, a stator, and a non-linear passage arranged between a first portion of the stator in face-sharing contact with the housing and a second portion of the stator spaced away from the housing.

As one example, one or more laminations of the electric motor shaping the feed channel and oil jets may be spaced away from portions of a stator to shape first and second portions of the feed channel. The one or more laminations may be in face-sharing contact with the stator at ends of the feed channel adjacent to the one or more oil jets to seal the feed channel such that coolant may exit the feed channel via only the oil jets. As one example, the wavy feed channel may be used in immersion cooling by allowing oil to flow from a first side of the stator, into the wavy channel, and out a second side of the stator, opposite the first side, to cool windings of the stator. By doing this, a sealing interface via rings or other components may be removed, which may reduce a cost and a weight of the electric motor relative to the examples introduced above.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a vehicle at least partially driven via an electric motor.

FIG. 2 shows a schematic diagram of a cooling system.

FIG. 3A shows a side sectional view of a first drive unit comprising one or more cooling channels integrally arranged therein.

FIG. 3B shows a side sectional view of a second drive unit comprising one or more cooling channels integrally arranged therein.

FIG. 4A shows a side view of a stator of the second drive unit.

FIG. 4B shows a first cross-sectional view of the stator illustrating the cooling channels integrally arranged within the stator.

FIG. 4C shows a second cross-sectional view of the stator illustrating the cooling channels integrally arranged within the stator.

FIG. 5 shows a cooling channel with a single-direction wavy pattern and a circular cross section.

FIG. 6 shows a cooling channel with a single-direction wavy pattern and a square cross section.

FIG. 7 shows a cooling channel with a bi-directional wavy pattern.

FIG. 8 shows a graph illustrating the thermal resistance of cooling channels at different pumping powers.

### DETAILED DESCRIPTION

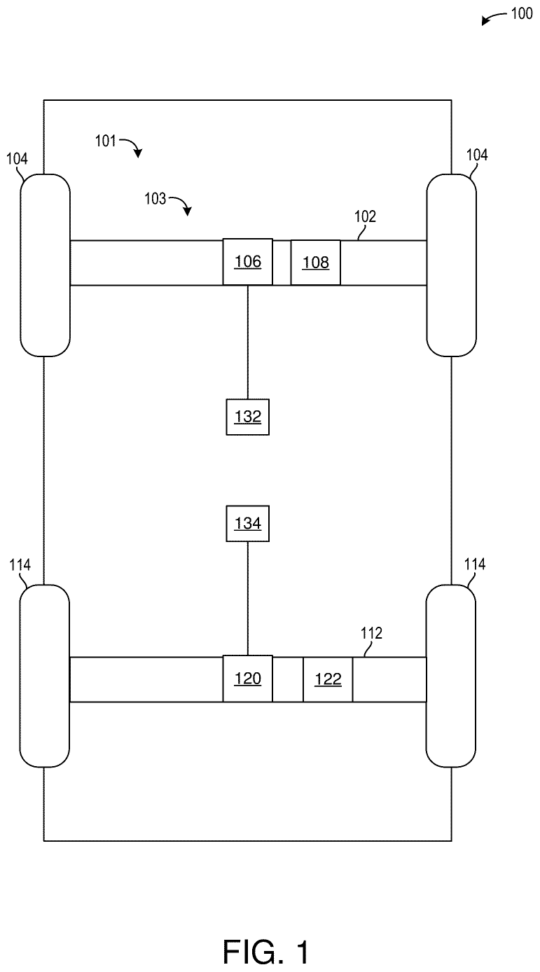

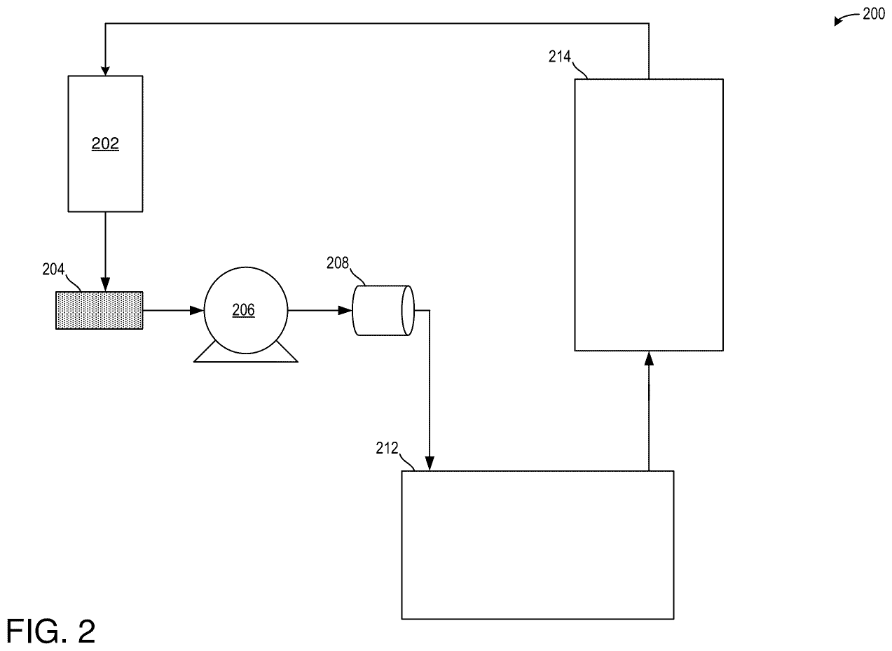

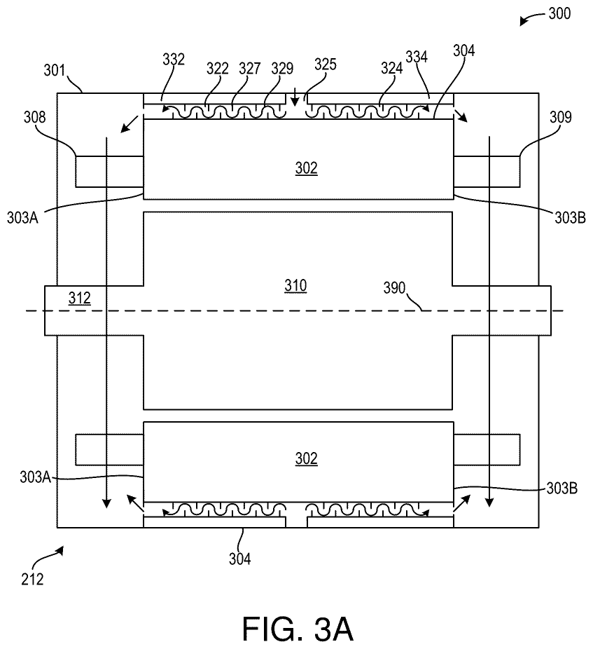

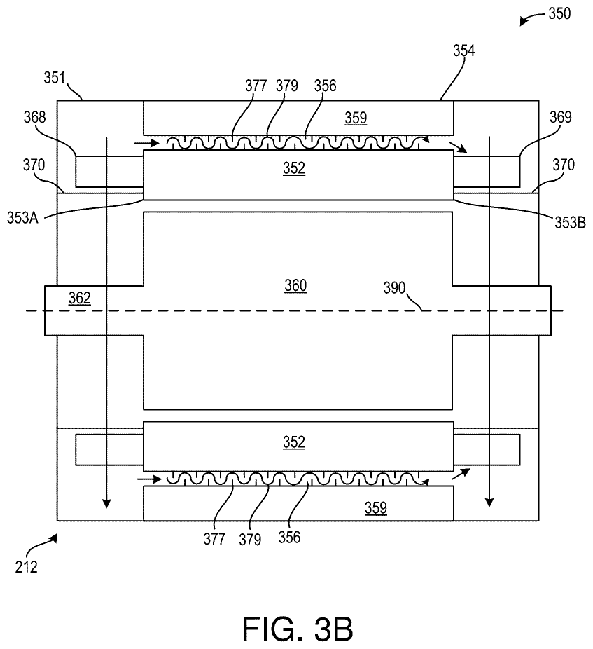

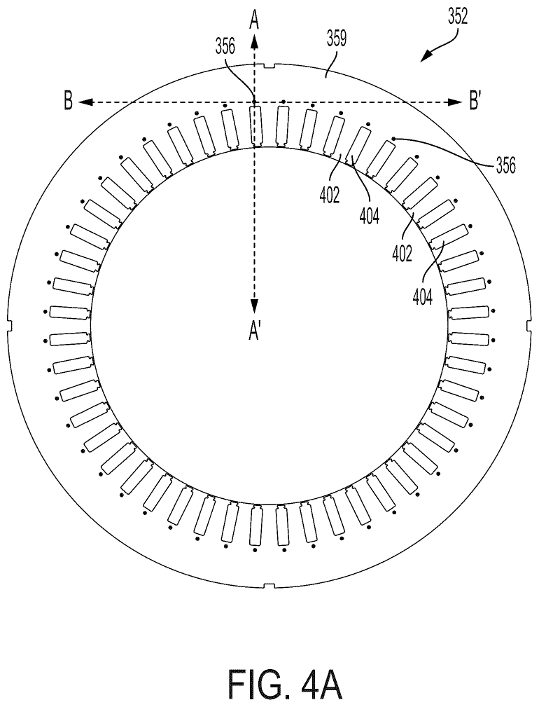

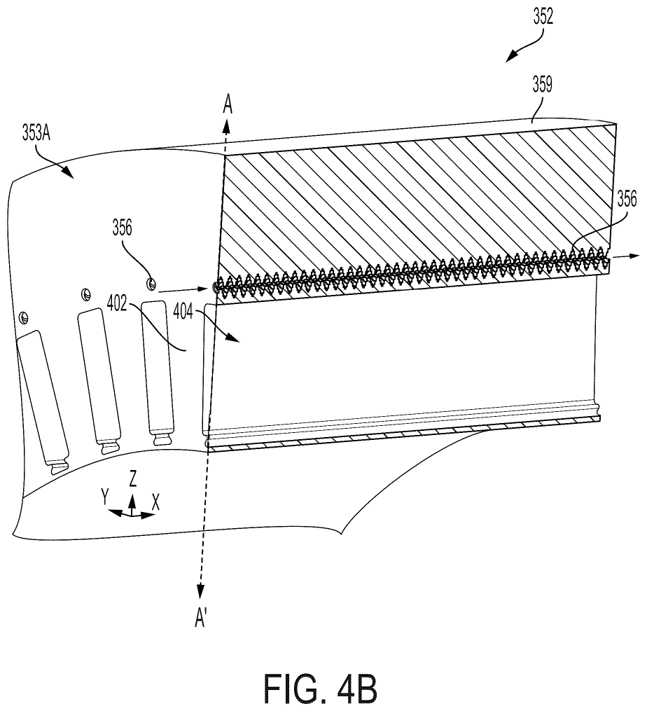

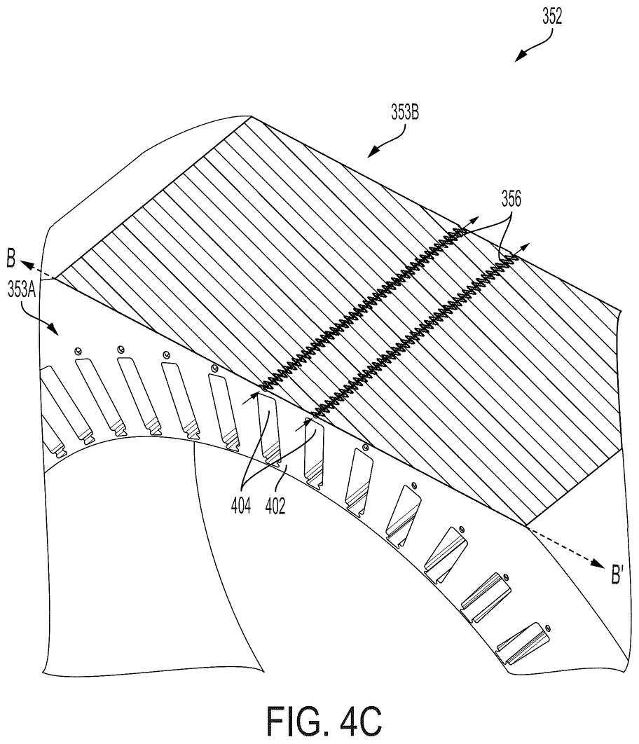

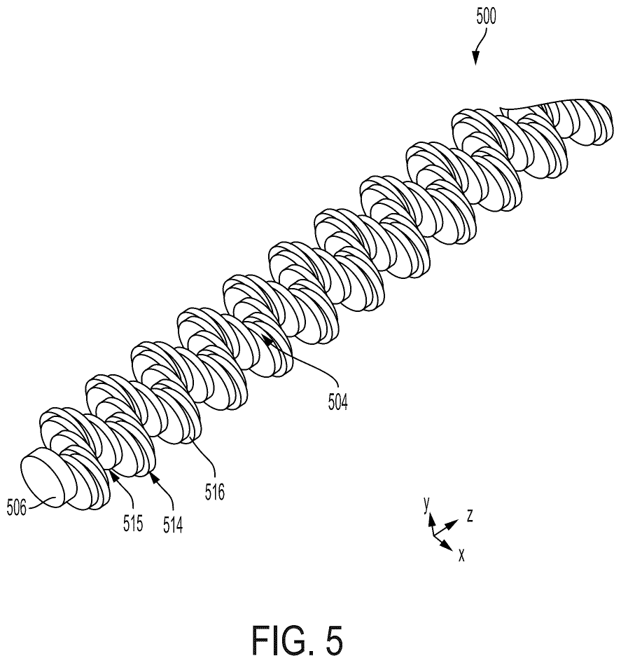

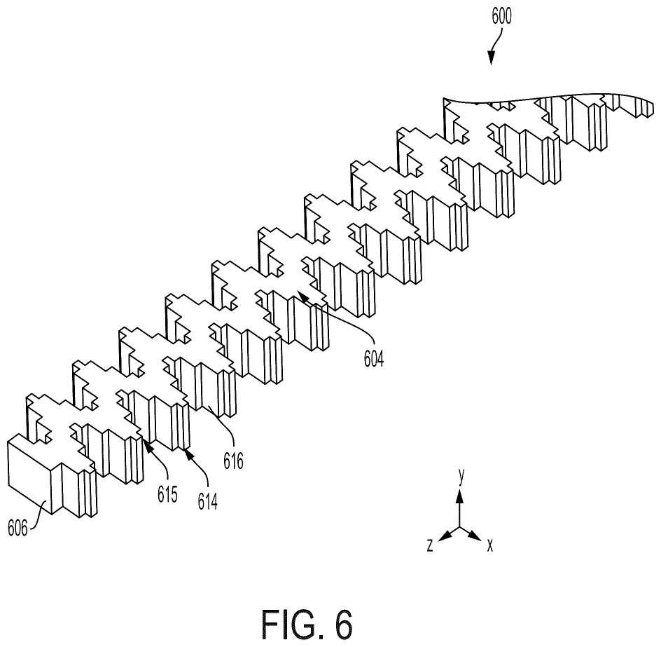

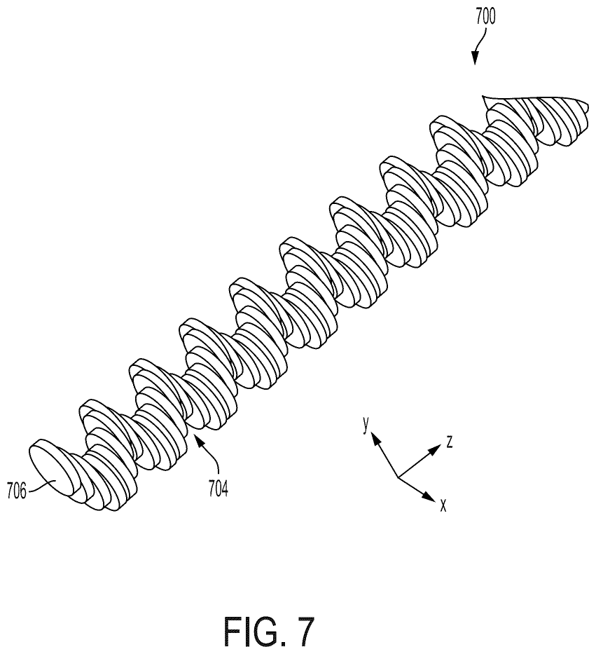

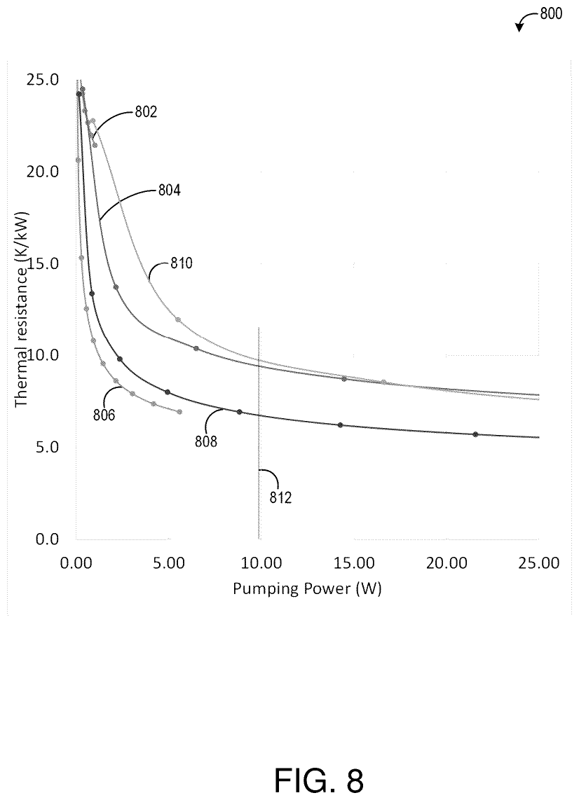

The following description relates to systems for a cooling arrangement for a drive unit. In one example, the drive unit is an electric motor of a vehicle, as illustrated in FIG. 1. The cooling arrangement may be an oil-based cooling arrangement fluidly coupled to the electric motor and a gear housing, as illustrated in FIG. 2. The cooling arrangement may be shaped and sealed via laminations of the stator, as shown in FIGS. 3A and 3B. The cooling arrangement may include non-linear passages positioned within the stator laminations, where each non-linear passage includes a pattern of holes in laminated plates arranged in series within the stator lamination. FIGS. 4A-4C shows detailed views of the stator of FIG. 3B, illustrating the plurality of wavy cooling channels distributed circumferentially about the stator. In some examples, the non-linear passage may include a single-direction wavy pattern, as illustrated in FIGS. 5 and 6. In other examples, the non-linear passages may include a bi-directional wavy pattern, such as the cooling channel shown in FIG. 7. FIG. 8 illustrates that the pattern of the wavy cooling passage within each non-linear passage, as well as the cross-sectional shape of each non-linear passage, may at least in-part determine the thermal resistance of the non-linear passage.

FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 4A-7 are drawn approximately to scale. However, other dimensions may be used if desired.

Turning now to FIG. 1, a vehicle 100 is shown comprising a powertrain 101 and a drivetrain 103. The powertrain 101 comprises a prime mover 106 and a transmission 108. The prime mover 106 may be an internal combustion engine (ICE) or an electric motor, for example, and is operated to provide rotary power to the transmission 108. The transmission 108 may be any type of transmission, such as a manual transmission, an automatic transmission, or a continuously variable transmission. Herein, the transmission 108 may be interchangeably referred to as a gearbox. The transmission 108 receives the rotary power produced by the prime mover 106 as an input and outputs rotary power to a first axle assembly 102 in accordance with a selected gear or setting. In one example, the prime mover 106 is one of a plurality of prime movers, wherein each of the prime movers may include various powertrain components for supplying power to a first set of wheels 104 and/or other components of the vehicle 100.

The prime mover 106 may be powered via energy from an energy storage device 132. In one example, the energy storage device 132 is a battery configured to store electrical energy. An inverter may be arranged between the energy storage device 132 and the prime mover 106 and may be configured to adjust direct current (DC) to alternating current (AC). The inverter may include a variety of components and circuitry with thermal demands that effect an efficiency of the inverter.

The vehicle 100 may be a commercial vehicle, light, medium, or heavy duty vehicle, a passenger vehicle, an off-highway vehicle, and sport utility vehicle. Additionally or alternatively, the vehicle 100 and/or one or more of its components may be in industrial, locomotive, military, agricultural, and aerospace applications. In one example, the vehicle 100 is an all-electric vehicle or a vehicle with all-electric modes of operation, such as a plug-in hybrid vehicle. As such, the prime mover 106 is an electric machine. In one example, the prime mover 106 is an electric motor/generator.

In some examples, such as shown in FIG. 1, the drivetrain 103 includes the first axle assembly 102 and a second axle assembly 112. The first axle assembly 102 may be configured to drive the first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In the illustrated example, the powertrain 101 includes a prime mover 120 and a transmission 122. The prime mover 120 may be an internal combustion engine (ICE) or an electric motor, for example, and is operated to provide rotary power to the transmission 122. The transmission 122 may be any type of transmission, such as a manual transmission, an automatic transmission, or a continuously variable transmission. Herein, the transmission 122 may be interchangeably referred to as a gearbox. The transmission 122 receives the rotary power produced by the prime mover 120 as an input and outputs rotary power to the second axle assembly 112 in accordance with a selected gear or setting. In one example, the prime mover 120 is one of a plurality of prime movers, wherein each of the prime movers may include various powertrain components for supplying power to the second set of wheels 114 and/or other components of the vehicle 100.

The prime mover 120 may be powered via energy from an energy storage device 134. In one example, the energy storage device 134 is a battery configured to store electrical energy. An inverter may be arranged between the energy storage device 134 and the prime mover 120 and may be configured to adjust direct current (DC) to alternating current (AC). The inverter may include a variety of components and circuitry with thermal demands that effect an efficiency of the inverter.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

Turning now to FIG. 2, it shows a schematic diagram of a cooling and lubrication system 200 which may be arranged in the vehicle 100 of FIG. 1. The cooling and lubrication system may be configured to circulate a fluid, for example oil, through various components of an electric drive unit used in an electric passenger vehicle, for example. Though the embodiments described herein are in the context of an oil-based system, other fluids may be used. For example, any fluid which provides adequate lubrication, heat transfer, dielectric properties, and flow properties, for a particular application or pump size, may be used.

Lubricant may be arranged in an oil reservoir 202, which may include a sump or dry sump system (e.g. an oil reservoir external to the drive unit), and may flow through a meshed filter 204 to an electric pump system 206. Oil pumped out of electric pump system 206 then passes through oil filter 208. From oil filter 208, the oil then flows through motor 212 to gear box 214. Motor 212 may be a non-limiting example of the prime mover 106 and/or the prime mover 120 of FIG. 1. Gear box 214 may be a non-limiting example of the transmission 108 and/or the transmission 122 of FIG. 1.

With respect to oil flowing to motor 212, it may flow through channels in a stator lamination to cool windings of a stator. From the motor 212, oil may return to the oil reservoir 202. In some examples, the oil reservoir 202 may be positioned within the gear box 214 (e.g., within a transmission). Herein, the flow of oil through channels in the stator lamination is described in greater detail.

Turning now to FIG. 3A, it shows an embodiment 300 of a side-sectional view of the motor 212 of FIG. 2. As such, components previously introduced may be similarly numbered in this and subsequent figures. The motor 212 may include a stator 302. The stator 302 may comprise a hollow, cylindrical shape that surrounds an outer surface of and is concentric with a rotor 310 coupled to a rotor shaft 312. As illustrated, a gap, such as an air gap, may be arranged between an interior surface of the stator 302 and the outer surface of the rotor 310. The stator 302 may further include a first side surface 303A, a second side surface 303B, and an outer surface 304, distal to the portion of the stator 302 surrounding the rotor 310. The outer surface 304 of the stator 302 may be in face-sharing contact with an interior surface of a housing of the motor 212.

A first cooling channel 322 and a second cooling channel 324 may be arranged entirely within laminations of the stator 302. The first cooling channel 322 and the second cooling channel 324 may form one pair of cooling channels of a plurality of pairs of cooling channels distributed about the stator 302. As illustrated, the first and second cooling channels 322, 324 may be thermally coupled to the outer surface 304 of the stator 302 via a portion of the stator laminations. The first cooling channel 322 and the second cooling channel 324 may be non-linear cooling channels. An inlet 325 may be centrally located and configured to direct oil to the first cooling channel 322 and the second cooling channel 324. In one example, the first cooling channel 322 and the second cooling channel 324 bifurcate from the inlet 325 in opposite directions toward the first side surface 303A and the second side surface 303B, respectively. The first and second cooling channels 322, 324 extend in axially opposite directions, parallel to a central axis 390 of the rotor shaft 312. The first and second cooling channels 322, 324 may be integrally arranged in first and second stator laminations 332, 334, respectively. The first and second cooling channels 322, 324 may be sealed via the first and second stator laminations 332, 334. In one example, the first stator laminations 332, in combination with the first side surface 303A shape the first cooling channel 322. The second stator laminations 334, in combination with the second side surface 303B shape the second cooling channel 324.

Stator laminations, including the first and second stator laminations 332, 334, may extend along an entire axial length of the stator 302 and may be radially positioned between the stator 302 and the motor housing 301. In one example, a portion of each of the first stator lamination 332 and the second stator lamination 334 may be free of the first cooling channel 322 and the second cooling channel 324. In one example, the first cooling channel 322 and the second cooling channel 324 may be located in a position of the stator 302 closer to the housing of the motor 301 than to the rotor 310. In this way, the portion of the first stator lamination 332 and the second stator lamination 334 free of the cooling channel may be sealed from coolant and other fluids and positioned between the motor housing 301 and the first cooling channel 322 and the second cooling channel 324.

The first end winding 308 may extend axially from the first side surface 303A and the second end winding 309 may extend axially from the second side surface 303B. In one example, the stator laminations shape the first and second cooling channels 322, 324, such that the cooling channels are integrally arranged in the lamination stack. Thus, the cooling channels may be completely shaped via the laminations, glue, and impregnation such that any openings and seals of the cooling channels are shaped via the laminations, glue, and impregnation. In some examples, as will be further described below, the cooling channels 322, 324 may be formed by holes in laminated plates of the stator lamination, whereby each hole is offset by a predefined distance from neighboring holes (e.g., the two holes that are adjacent to a given hole). Thus, the first and second stator laminations 332, 334 are shown with fin extensions 327, which may be regions of the laminations that correspond to the offsets.

In one example, a portion of an opening into the cooling channels may be shaped by the motor housing 301. The portions of the cooling channels within an interior volume of the motor housing 301 may be completely shaped via the laminations, glue, and impregnation. By doing this, a cost and a complexity to manufacture the cooling channels into pre-existing electric motor configurations may be reduced relative to other cooling configurations. The shape of the cooling channels, as will be described in greater detail herein, may enhance cooling provided to the components of the electric motor relative to other cooling configurations.

The first cooling channel 322 and the second cooling channel 324 may each be configured with non-linear fluid conduits. As such, fluid passing through each of the first cooling channel 322 and the second cooling channel 324 move in a wavy pattern as denoted by arrows 329. In some examples, the wavy pattern may force fluid to follow a two-dimensional (2D) wave (e.g., zig zag or sinusoidal) pattern, with oscillations along a single axis (e.g., a radial axis) that is orthogonal to the longitudinal axes of the cooling channels. In other examples, the wavy pattern may force fluid to follow a three-dimensional (3D) wave pattern, with oscillations along two axes that are orthogonal to the longitudinal axes of the cooling channels. In some examples, both the first cooling channel 322 and the second cooling channel 324 may include the same configuration of wavy fins that cause a 2D or a 3D pattern. In other examples, the first cooling channel 322 and the second cooling channel 324 may include different configurations of wavy fins such that the first cooling channel 322 includes a 2D pattern and the second cooling channel 324 includes a 3D pattern. In some examples, the wavy fins may cause fluid flow to follow a sinusoidal pattern.

As noted, the wavy cooling channels illustrated in FIG. 3A may be one of a plurality of wavy cooling channel pairs that are distributed equidistant from each other around a circumference of the stator 302. Additionally or alternatively, the shape, position, and/or configuration of channels may be adjusted at different areas of the circumference of the stator 302 to modify cooling to account for different components at different radial positions of the electric motor 212.

Coolant from the cooling channels (e.g., the first cooling channel 322 and the second cooling channel 324) may be directed to the end windings (e.g., the first end winding 308 and the second end winding 309, respectively) of the stator 302. For example, the first cooling channel 322 and the second cooling channel 324 may each optionally lead to a nozzle jet that sprays coolant onto the first end winding 308 and the second end winding 309, respectively. Additionally or alternatively, the passages may direct oil to a spray ring or reservoir axially outside of a profile of the stator 302 (e.g., within a volume of space between the stator 302 and the motor housing 301).

Turning now to FIG. 3B, it shows an embodiment 350 of a side-sectional view of the motor 212 of FIG. 2. The motor 212 may include a motor housing 351 and a stator 352. The stator 352 may comprise a hollow, cylindrical shape that surrounds an outer surface of a rotor 360 coupled to a rotor shaft 362. As illustrated, a gap, such as an air gap, may be arranged between the stator 352 and the rotor 360. The stator 352 may further include a first side surface 353A positioned at a crown side of the stator, a second side surface 353B positioned at the weld side of the stator, and an outer surface 354 distal to the portion of the stator 352 surrounding the rotor 360. The first side surface 353A is at an opposite axial side of the stator 352 relative to the second side surface 353B.

A cooling channel 356 may be arranged within a lamination of the stator 352 such that the cooling channel is parallel to the central axis 390 of the rotor shaft 362. The cooling channel 356 may be one of a plurality of cooling channels distributed about the stator 352. As will be further described with respect to FIGS. 4A-4C, each wavy cooling channel may be positioned above a corresponding slot of the stator winding. In alternative examples, more than one, such as two or three, wavy cooling channels may correspond to a single slot.

As illustrated, the cooling channel 356 may be thermally coupled to the stator 352. The cooling channel 356 may receive oil at a first end positioned proximate to the crown side of the stator 352 (e.g., proximate to the first side surface 353A). Oil may then flow through the cooling channel 356 from the crown side to the weld side (e.g., from the first side surface 353A to the second side surface 353B). The cooling channel 356 may be integrally arranged in the stator 352, wherein the cooling channel may be completely shaped via a lamination stack of the stator 352 or via surfaces of the stator 352. The example shown in FIG. 3B illustrates immersion cooling wherein coolant enters a first side of the motor and is directed to a second side of the motor prior to exiting the motor to flow to a remainder of a cooling system. In the immersion cooling system shown in FIG. 3B, seals 370 may be included in the stator 352 to seal the rotor 360 from the coolant. The lamination stack 359 may be sealed from the cooling channel 356 and positioned between the housing 301 and the cooling channel 356. In one example, the cooling channel 356 may be a non-linear cooling channel.

The cooling channel 356 may be configured with non-linear fluid conduits. In one example, the non-linear fluid conduits include wavy fins 377. As such, fluid passing through the cooling channel 356 moves in a wavy pattern as denoted by arrows 379. In some examples, the wavy fins 377 may force fluid to follow a two-dimensional (2D) wave pattern, with oscillations along one axis that is orthogonal to the longitudinal axis of the cooling channel (e.g., along an axial direction of the cooling channel relative to the stator 352). In other examples, the wavy fins 377 may force fluid to follow a three-dimensional (3D) wave pattern, with oscillations along two axes that are angled to the longitudinal axis of the cooling channel. The cooling channel 356 may be uniform along an entire circumference of the stator 352. Additionally or alternatively, in some examples, the cooling channel 356 may be non-uniform to provide tailored cooling to different sections of the electric motor 212 based on thermal demands and component positioning.

The stator 352 may include a first end winding 368 and a second end winding 369. The first end winding 368 may receive coolant flow via immersion with use of an external pump, similar to as described with respect to FIG. 2. The second end winding 369 may receive coolant via immersion and/or the cooling channel 356.

Turning now to FIGS. 4A-4C, the stator 352 of FIG. 3B is shown. In FIG. 4A, the stator 352 is shown from a side view. As described above, a plurality of cooling channels 356 may be distributed circumferentially around the stator 352, within the stator lamination 359. FIG. 4B shows a perspective cross-sectional view of the stator 352 across a first cutting plane A-A′. FIG. 4C shows a perspective cross-sectional view of the stator 352 across a second cutting plane B-B′

The stator 352 may comprise a winding with a plurality of teeth 402 and a plurality of slots 404. The plurality of teeth 402 and the plurality of slots 404 may alternate such that each slot is positioned between two teeth and each tooth is positioned between two slots. In some examples, each of the plurality of cooling channels 356 may correspond to one of the plurality of slots 404. As described with respect to FIG. 3B, the plurality of cooling channels 356 may be embedded or otherwise integrated within the stator lamination 359. In other examples, the channels may correspond to the position of the teeth (e.g., may be positioned between the slots).

In the example shown, the slot to cooling channel ratio may be 1:1. In a 1:1 example as shown, the plurality of cooling channels 356 may be arranged equidistant from each other about the stator 352. It should be understood that in other examples, the slot to cooling channel ratio may be different, such as 1:2 or 1:3. In such examples, multiple cooling channels may be stacked on top of each other above each slot. In other examples, the cooling channels may be arranged in a single row circumferentially about the stator such that sets of cooling channels are arranged horizontal next to each other, both above a corresponding slot. In practice, with immersion cooling, oil may be directed from the first side surface 353A towards the second side surface 353B, as shown by the arrows in FIGS. 4B and 4C.

As shown in FIGS. 4B and 4C, each of the plurality of cooling channels 356 may have a wavy configuration. Further, each of the plurality of cooling channels 356 may be integrated into the stator lamination 359. The wavy configuration of the plurality of cooling channels 356 is shown in FIGS. 4B and 4C as a periodic single channel, though it should be understood that other configurations are possible, as will be further described below. As will be described in greater detail below, each of the plurality of cooling channels 356 may be formed as a plurality of same size holes in laminated plates arranged in series with offsets. As a non-limiting example, each plate may be offset by a distance of 0.5 mm from an adjacent plate. The offsets may be arranged in a repeating cycle arrangement, such as 8 laminates per cycle. Thus, the cooling channels may form a sinusoidal shape as the plates oscillate via the offsets. By forming the channels as a plurality of same size holes in laminated plates, the wavy cooling channels may be formed within the stator lamination.

Turning now to FIG. 5, a cooling system 500 is illustrated. FIGS. 5-7 include a Cartesian coordinate system to orient the views. The y-axis may be a vertical axis (e.g., along a radial direction), the x-axis may be a lateral axis (e.g., along a second radial direction), and the z-axis may be an axial axis (e.g., along a center of rotation), in one example. However, the axes may have other orientations, in other examples.

The cooling system 500 includes a non-linear cooling channel 504, where the cooling channel is positioned within a stator lamination. In one example, the stator lamination shapes the cooling channel 504 such that the cooling channel 504 is integrally arranged within and embedded into the stator lamination, as described with respect to FIGS. 4A-4C. The stator lamination may seal the cooling channel 504 in a radial direction along an x-y plane. The cooling channel 504 may be a non-limiting example of the cooling channel 356 of FIG. 3B. As such, the cooling channel 504 may include an inlet 506, which directs coolant from a coolant source into the cooling channel. In one example, the coolant is oil or another fluid (e.g., dielectric fluid or the like). The cooling channel 504 may be configured to carry oil for cooling a stator of an electric machine, such as an electric motor (e.g., the prime mover 106 or the prime mover 120 of FIG. 1 or the electric motor 212 of FIGS. 2-3B). In the illustrated example, the cooling channel 504 has a circular cross-section (e.g., along the x-y plane), however, the cooling channel may include a different shaped cross section such as square, rectangular, triangular, pentagonal, or the like in other examples, though a circular cross-section may provide for an easier flow than other shapes.

Along the length of the cooling channel 504, an amount that the cooling channel 504 deviates along the x-axis (e.g., an offset amount) relative to a neighboring position of the cooling channel may vary. As an example, as described above, each laminate may deviate by an offset distance of 0.5 mm relative to a neighbor in a sinusoidal pattern with cycles of 8 laminates. For example, the cooling channel 504 may be offset by a smaller amount at a point proximate to an apex (e.g., a peak) of a bend, relative to a point that is between two bends. As such, an offset of the cooling channel 504 at a point 514 may be larger than an offset of the cooling channel at a point 516, relative to the x-axis. Further, the height of the cooling channel 504 may remain consistent along the length of the cooling channel such that the topmost point (e.g., relative to the y-axis) of the cooling channel at each bend and the offset is positioned within the same plane, where the plane is parallel to the x-z plane.

In another example, additionally or alternatively, the cooling channel 504 may be shaped via a plurality of discs formed by the stator lamination. Each of the discs may overlap with one another along the z-direction. An amount of offset for each neighboring disc may vary to create a desired amount of turbulence (e.g., mixing) within the cooling channel 504. For example, as the cooling channel 504 zig-zags, a first amount of offset may be present at an apex (e.g., the point 514). A second amount of offset may be present at a linear section 515. The second amount of offset may be different than the first amount of offset. In one example, the second amount of offset is greater than the first amount of offset. The apex at the point 514 may be one of a plurality of apexes and the linear section 515 may be one of a plurality of linear sections. The apexes and linear section may alternate with one another to produce the zig-zag pattern of the cooling channel 504.

In some examples, the pattern of the wavy fins 408 may be obtained by indexing adjacent sections of lamination. Further, in some examples, the wavy fins 408, and therefore the cooling channel 504, may follow a sinusoidal pattern of oscillation that varies the radial and/or tangential location of the cooling channel 504 within a plane parallel to the x-z plane.

The wavy fins 408 may promote flow mixing and increased turbulence within the cooling channel 504 by forcing oil within the cooling channel to swirl and therefore frequently changing the oil that is in direct contact with the stator lamination (e.g., the boundary layer of oil). Additionally, at each bend of the wavy fins 408 (e.g., the inner bend 410 and the outer bend 412), oil flow within the cooling channel 504 changes direction. As such, oil within the cooling channel 504 may flow both axially and tangentially, and may better transfer heat from the stator lamination than oil travelling through a cooling system without wavy fins or following a linear flow path. Further, the wavy fins 408 may increase heat transfer between oil in the cooling channel 504 and the stator lamination by increasing the heat transfer area (e.g., the contact surface area) between the cooling channel and the stator lamination. In one example, the wavy fins 408 may disrupt laminar flow of the coolant. As such, thermal dissipation through the oil may be enhanced via the turbulence introduce by the wavy fins 408. By doing this, stator temperatures may be more controlled and oil temperatures through the cooling channel 504 may be more uniform compared to other cooling channels with hot spots near an outside of the cooling channel.

FIG. 6 shows a cooling system 600, including a non-linear cooling channel 604, where the cooling channel is positioned within the stator lamination. The cooling channel 604 may be a non-limiting example of one of the first cooling channel 322 or the second cooling channel 324 of FIG. 3A or the cooling channel 356 of FIG. 3B. The cooling channel 604 may include an inlet 606, which directs oil from an oil source into the cooling channel. The cooling channel 604 may be configured to carry oil for cooling a stator of an electric machine, such as an electric motor (e.g., the prime mover 106 or the prime mover 120 of FIG. 1 or the electric machine 212 of FIGS. 2-3B). The cooling channel 604 has a square cross section (e.g., along the x-y plane). In other examples, the cooling channel 604 may have a different cross-sectional shape, which may be determined by the thermal performance, flow rates, packaging constraints, and pressure drop thresholds of the operating environment.

Along the length of the cooling channel 604, an amount that the cooling channel 604 moves along the x-axis (e.g., an offset amount) relative to a neighboring position of the cooling channel may vary. For example, the cooling channel 604 may be offset by a smaller amount at a point proximate to an apex (e.g., a peak) of a bend, relative to a point that is between two bends. As such, an offset of the cooling channel 604 at a point 614 may be larger than an offset of the cooling channel at a point 616, relative to the x-axis. Further, the height of the cooling channel 604 may remain consistent along the length of the cooling channel such that a top surface (e.g., relative to the y-axis) of the cooling channel is positioned within the same plane, where the plane is parallel to the x-z plane. In this way, the cooling channel 604 may include a zig-zag shape.

Said another way, the cooling channel 604 may include a plurality of cubes and/or rectangular prisms shaped via the stator lamination. Neighboring rectangular prisms of a plurality of rectangular prisms may at least partially overlap with one another, such that an offset is present and results in increased turbulence within the cooling channel 604. A first offset may be present at an apex (e.g., the point 614). A second offset may be present at a linear section 615, which may interconnect apices. Each linear section 615 of the cooling channel 504 may correspond to a section of the stator lamination between an inner bend and an outer bend. Each apex may correspond to an outer bend of the stator lamination. In one example, the first offset is less than the second offset. The plurality of rectangular prisms may be arranged such that a flow-through area of a first prism shifts is offset to a flow-through area of a second, neighboring prism in a stepwise manner. A top, sides, and bottom of the cooling channel 604 may be flat due to the square/rectangular cross-sectional shape of the cooling channel 604 along the x-y plane.

FIG. 7 shows a cooling system 700 including a non-linear cooling channel 704. The cooling channel 704 has a circular cross section and is positioned within a stator lamination. The stator lamination may shape and partially seal the cooling channel 704. The cooling channel 704 may be a non-limiting example of the first cooling channel 322 of FIG. 3A, the second cooling channel 324 of FIG. 3B, or the cooling channel 356 of FIG. 3B. As such, the cooling channel 704 may include an inlet 706, which directs oil from an oil source into the cooling channel. The cooling channel 704 may be configured to carry oil for cooling a stator of an electric machine, such as an electric motor (e.g., the prime mover 106 or the prime mover 120 of FIG. 1 or electric machine 212 of FIGS. 2-3B).

The stator lamination includes a bi-directional wavy fin design. The bi-directional wavy fin design may be obtained by indexing adjacent sections of the stator lamination in such a way that the location of the cooling channel 704 is varied in both the x-axis and y-axis along the length of the cooling channel (e.g., along the z-axis). Along the length of the cooling channel 704, a total amount that the cooling channel moves within the x-axis and the y-axis (e.g., an offset amount) may remain consistent. For example, a magnitude of the offset of the cooling channel 704 may be the same at any point along the cooling channel. The location of the cooling channel 704 along the x-axis and the y-axis may follow a sinusoidal pattern along the z-axis. The bi-directional wavy fin configuration may further increase flow mixing and fluid contact area, relative to the single direction wavy fin pattern of the cooling system 00 of FIG. 5, by causing the coolant to follow a spiraled/swirling pattern. Further, the shape of the cooling channel 704 may cause increased turbulence and, in some examples, may lead to a portion of the coolant temporarily flowing backwards (e.g., towards the inlet 706). The amplitude, wavelength, and cross section shape of the cooling channel 704 may be varied and/or optimized based on thermal performance and pressure drop thresholds.

Similar to the single directional wavy fin pattern of the cooling system 500 of FIG. 5, the bi-directional wavy fin pattern of the cooling system 700 of FIG. 7 may promote flow mixing within the cooling channel 704. Oil within the cooling channel 704 may contact sides of the cooling channel (e.g., wavy fins) and swirl in three dimensions (e.g., along multiple planes), therefore frequently changing the oil that is in direct contact with the stator lamination 602 (e.g., the boundary layer of oil). As such, oil within the cooling channel 704 may flow axially, tangentially, and radially (e.g., in three dimensions), and may better transfer heat from the stator lamination 602 than oil travelling through a cooling channel without wavy fins or with single-direction wavy fins due to the increased mixing. The bi-directional wavy fins may increase heat transfer between oil in the cooling channel 704 and the stator lamination by further increasing the heat transfer area (e.g., the contact surface area) between the cooling channel and the stator lamination. Additionally, the bi-directional wavy fin pattern of the cooling system 700 may decrease the convective thermal resistance of the cooling channel 704, significantly boosting performance of the electric machine that includes the cooling channel.

In one example, the cooling channel 704 may be shaped via a plurality of discs having a circular cross-sectional shape along the x-y plane. An offset between neighboring discs may be uniform along an entirety of the cooling channel 704. The cooling channel 704 may include a helix shape that flows coolant in a 3-D pattern, as opposed to the 2-D pattern of the cooling channels of FIGS. 5 and 6. In one example, the cooling channel 704 is a bidirectional sinusoidal channel. In some examples, additionally or alternatively, the offset between neighboring discs may be non-uniform while still flowing coolant in a 3-D pattern along the cooling channel 704.

FIG. 8 shows a graph 800 that illustrates the thermal resistance of various types of cooling channels for different pumping powers. The thermal resistance is measured in Kelvin per kilowatt (K/kW) and the pumping power is measured in watts (W). Line 802 represents a straight cooling channel with a circular cross section. Line 804 represents a single direction wavy fin cooling channel with a circular cross section (e.g., the cooling system 500 of FIG. 5) and a first sinusoidal wave amplitude. Line 806 represents a bi-directional wavy fin cooling channel with a circular cross section (e.g., the cooling system 700 of FIG. 7) and a second sinusoidal wave amplitude, where the second sinusoidal wave amplitude is smaller than the first sinusoidal wave amplitude of the line 804. Line 808 represents a bi-directional wavy fin cooling channel with a circular cross section and a third sinusoidal wave amplitude, where the third sinusoidal wave amplitude is smaller than the first sinusoidal wave amplitude of the line 804 and larger than the second sinusoidal wave amplitude of line 806. Line 810 represents a bi-directional wavy fin cooling channel with a circular cross section and the first sinusoidal wave amplitude (e.g., the same sinusoidal wave amplitude as the line 804). A vertical line 812 illustrates a pumping power of 10 watts.

The straight cooling channel represented by the line 802 may offer a low pressure drop and corresponding hydraulic power, as well as a high thermal resistance. The single direction wavy fin cooling channel represented by the line 804 may have a lower thermal resistance than the straight cooling channel represented by the line 802, particularly at pumping powers greater than 10 watts. The bi-directional wavy fin channels represented by the lines 806 and 808 may each have a further decreased thermal resistance, relative to the single direction wavy fin channel represented by the line 804. The bi-directional wavy fin channel represented by the line 810 may have a decreased thermal resistance, relative to the single direction wavy fin channel represented by the line 804, for pumping powers above approximately 18 watts. Thus, the bidirectional wavy fin channel may be selected for applications with higher pumping power demands.

The disclosure also provides support for an electric motor, comprising: a housing, a stator, and a non-linear passage integrated within a portion of a stator lamination spaced away from the housing. In a first example of the system, the non-linear passage zig-zags along a single plane parallel to a longitudinal axis of the stator. In a second example of the system, optionally including the first example, the non-linear passage comprises a helix shape. In a third example of the system, optionally including one or both of the first and second examples, the portion of the stator lamination comprising the non-linear passage is sealed from a portion of the stator lamination free of the non-linear passage. In a fourth example of the system, optionally including one or more or each of the first through third examples, the stator lamination comprises openings configured to jet fluid from the non-linear passage to end windings of the stator. In a fifth example of the system, optionally including one or more or each of the first through fourth examples, the stator lamination comprises a plurality of offset discs that shape the non-linear passage. In a sixth example of the system, optionally including one or more or each of the first through fifth examples, the stator lamination comprises a plurality of offset rectangular prisms that shape the non-linear passage. In a seventh example of the system, optionally including one or more or each of the first through sixth examples, the stator lamination comprises adjacent sections indexed relative to one another at a uniform offset.

The disclosure also provides support for a system, comprising: an electric motor comprising a housing, a stator arranged within the housing, and one or more cooling passages integrally arranged within a stator lamination of the stator, wherein the one or more cooling passages are non-linear. In a first example of the system, the stator lamination surrounds and shapes the one or more cooling passages, wherein the one or more cooling passages extend over a periphery of the stator lamination near a stator winding slot. In a second example of the system, optionally including the first example, the stator lamination comprises wavy fins. In a third example of the system, optionally including one or both of the first and second examples, the wavy fins adjust a coolant flow through the one or more cooling passages into a two-dimensional zig-zag shape along a single plane parallel to a longitudinal axis of the stator. In a fourth example of the system, optionally including one or more or each of the first through third examples, the wavy fins shape the one or more cooling passages into a helix shape. In a fifth example of the system, optionally including one or more or each of the first through fourth examples, the one or more cooling passages are arranged closer to the housing than to a rotor which the stator surrounds. In a sixth example of the system, optionally including one or more or each of the first through fifth examples, the stator lamination is shaped to force the one or more cooling passages to jet fluid onto end windings of the stator.

The disclosure also provides support for a cooling system for an electric motor, comprising: a non-linear cooling passage integrally arranged in a lamination stack of a stator, wherein the non-linear cooling passage is shaped entirely by the lamination stack. In a first example of the system, the non-linear cooling passage undulates along a single plane. In a second example of the system, optionally including the first example, the non-linear cooling passage spirals along multiple planes. In a third example of the system, optionally including one or both of the first and second examples, the non-linear cooling passage directs fluid toward end windings of the stator. In a fourth example of the system, optionally including one or more or each of the first through third examples, the non-linear cooling passage comprises two passages that bifurcate from an inlet extending through a housing of the electric motor.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric motor, comprising:
a housing;
a stator; and
a non-linear passage integrated within a portion of a stator lamination spaced away from the housing.

2. The electric motor of claim 1, wherein the non-linear passage zig-zags along a single plane parallel to a longitudinal axis of the stator.

3. The electric motor of claim 1, wherein the non-linear passage comprises a helix shape.

4. The electric motor of claim 1, wherein the portion of the stator lamination comprising the non-linear passage is sealed from a remaining portion of the stator lamination free of the non-linear passage.

5. The electric motor of claim 1, wherein the stator lamination comprises openings configured to jet fluid from the non-linear passage to end windings of the stator.

6. The electric motor of claim 1, wherein the stator lamination comprises a plurality of offset discs that shape the non-linear passage.

7. The electric motor of claim 1, wherein the stator lamination comprises a plurality of offset rectangular prisms that shape the non-linear passage.

8. The electric motor of claim 1, wherein the stator lamination comprises adjacent sections indexed relative to one another at a uniform offset.

9. A system, comprising:
an electric motor comprising a housing;
a stator arranged within the housing; and
one or more cooling channels integrally arranged within a stator lamination of the stator, wherein the one or more cooling channels are non-linear.

10. The system of claim 9, wherein the stator lamination surrounds and shapes the one or more cooling channels, wherein the one or more cooling channels extend to a periphery of the stator lamination near an end winding of the stator.

11. The system of claim 9, wherein the one or more cooling channels each comprise a plurality of holes in laminated plates of the stator lamination arranged in series with offsets in a sinusoidal shape.

12. The system of claim 9, wherein the one or more cooling channels comprise a two-dimensional sinusoidal shape along a single plane parallel to a longitudinal axis of the stator.

13. The system of claim 9, wherein the one or more cooling channels form a helix shape.

14. The system of claim 9, wherein the one or more cooling channels are arranged closer to the housing than to a rotor which the stator surrounds.

15. The system of claim 9, wherein the stator lamination is shaped to force the one or more cooling channels to jet fluid onto end windings of the stator.

16. A cooling system for an electric motor, comprising:
a plurality of non-linear cooling channels integrally arranged in a lamination stack of a stator, wherein each non-linear cooling channel of the plurality of non-linear cooling channels is shaped entirely by the lamination stack.

17. The cooling system of claim 16, wherein each non-linear cooling channel undulates along a single plane.

18. The cooling system of claim 16, wherein each non-linear cooling channel spirals along multiple planes.

19. The cooling system of claim 16, wherein each non-linear cooling channel directs fluid toward end windings of the stator.

20. The cooling system of claim 16, wherein each non-linear cooling channel comprises two passages that bifurcate from an inlet extending through a housing of the electric motor.
